(19) United States
(12) Patent Application Publication
(10) Pub. No.: US 2020/0217120 A1
(43) Pub. Date: Jul. 9, 2020

(54) Improvements in Damped Closure Mechanisms

(71) Applicant: Titus d.o.o. Dekani, Dekani (SI)

(72) Inventors: Danijel Kozlovic, Dekani (SI); Valter Svara, Izola (SI)

(21) Appl. No.: 16/625,041

(22) PCT Filed: Jun. 21, 2018
(86) PCT No.: PCT/EP2018/066660

§ 371 Date: Dec. 20, 2019

(30) Foreign Application Priority Data
Jun. 23, 2017 (GB) 1710092.6

(51) Int. Cl. E05F 5/02; E05C 3/00; E05C 5/02; E05F 1/10

(52) U.S. Cl. CPC E05F 5/027; E05C 3/004; E05C 2005/005; E05F 1/1066; E05C 5/02

(57) ABSTRACT

A damped closure mechanism is provided for controlling movement of a first member relative to a second member, for example the door (12) of an oven (11). The mechanism comprises a housing (14) having a main spring which is engagable with the oven door (12) for urging it towards its closed position and a damper (25) for providing damped resistance to this closing movement. The mechanism further comprises a second spring (29) which is also engagable with the oven door (12) for urging it towards its closed position. The second spring (29) is arranged to act in parallel with the main spring (24), and serves to hold the door (12) shut with spring force.

This invention relates to damped closure mechanisms for use in particular, though not exclusively, on oven doors.

The invention provides a damped closure mechanism for controlling movement of a first member relative to a second member, the mechanism comprising a housing having first spring biassing means engagable with the first member in use for urging it in a first direction, damping means for providing damped resistance to said movement of the first member in the first direction, and second spring biassing means engagable with the first member for urging it in the first direction, the second spring biassing means being arranged to act on the first member in parallel with the first spring biassing means.

By way of example, embodiments of the invention will now be described with reference to the accompanying drawings, in which:

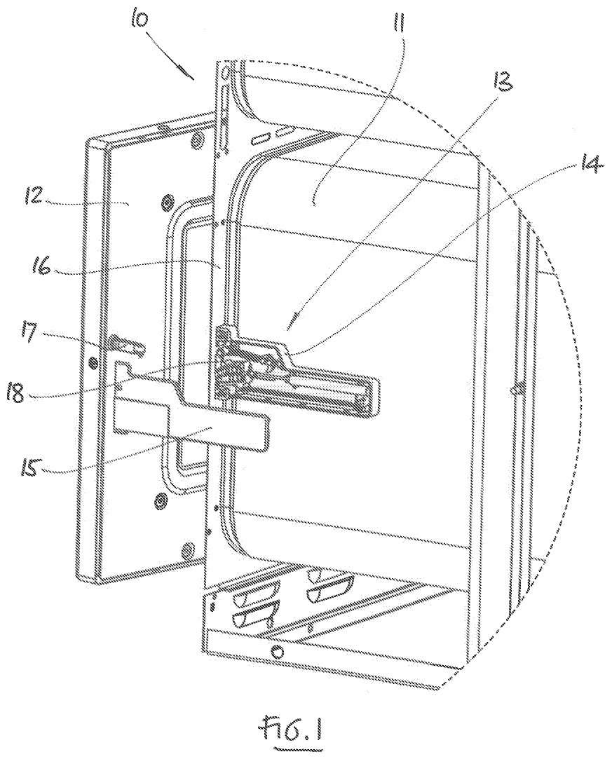

FIG. 1 is a schematic illustration of a cooker incorporating a damped closure mechanism according to the invention,

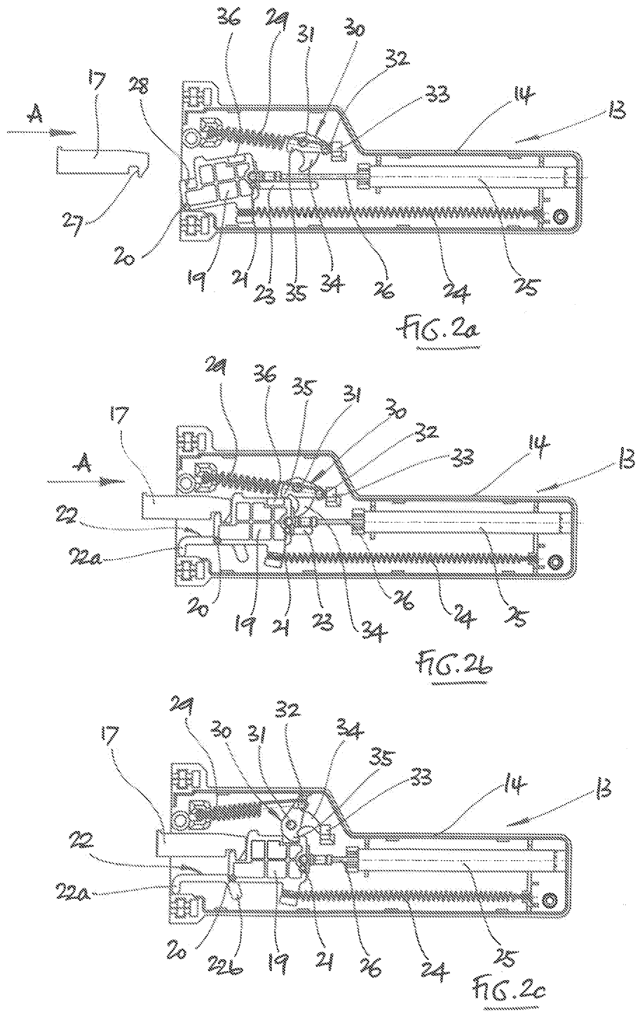

FIGS. 2a to 2c illustrate various stages in normal operation of the mechanism, and

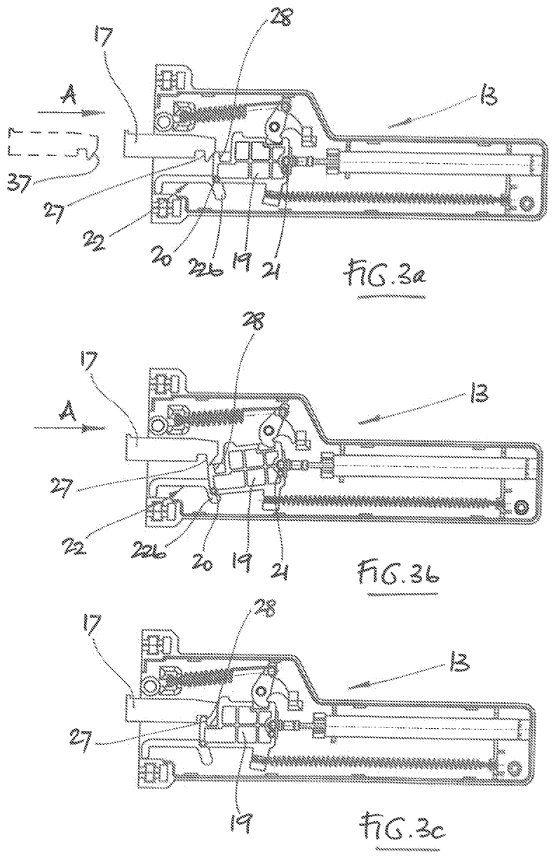

FIGS. 3a to 3c illustrate various stages in the re-setting procedure for the mechanism.

Illustrated in FIG. 1 is a cooker 10 having an oven 11 with an oven door 12 (with the side panel of the cooker having been omitted for convenience to reveal the damped closure mechanism 13 incorporated within it).

The oven door 12 here is one that is mounted via a vertically extending hinge (not shown) on one side of the cooker 10. The door 12 thus swings in a horizontal plane, with the mechanism 13 serving to control its closure on the opposite side of the cooker, spaced remotely from the hinge.

The mechanism 13 comprises an elongate housing 14 in which the various component parts are contained, and which is closed off by a cover 15 (with the cover shown here in exploded view). The mechanism 13 is mounted by the front edge of its housing 14 to a flange 16 at the front of the oven 11 by means of suitable fasteners. The mechanism 13 is arranged to extend back from the flange 16 and lie in the void between the outer sidewall of the oven 11 and the cooker side panel.

The mechanism 13 is designed to be operatively engagable by a trigger 17 mounted on the inside surface of the oven door 12, via a hole 18 in the flange 16. The mechanism 13 is designed to transmit a damped pulling force to the oven door 12 to assist its closing movement. It is also designed to exert a pulling force on the door 12 in its closed position in order to hold it shut and prevent heat escaping from the oven 11 in use.

The component parts of the mechanism 13 are seen more clearly in FIGS. 2a to 2c. These include an actuator 19 which is mounted for slidable and pivotal movement relative to the housing 14. The actuator 19 has first and second pins 20, 21 that are arranged to engage in respective guide tracks 22, 23 to control its movement. The guide tracks 22, 23 extend generally parallel to the direction of sliding travel of the actuator 19, shown by arrow A, with the guide track 22 for the first pin 20 having specially angled sections 22a, 22b at either end for purposes that will be described in more detail below.

One end of a tension spring 24 is attached to the actuator 19 at its lower corner. The other end of this spring 24 is attached to the housing 14. The spring 24 exerts a continuous force on the actuator 19 in the direction of arrow A.

A linear piston and cylinder type damping device 25 is mounted by its cylinder to the housing 14. The damping device 25 is aligned with the direction of sliding travel of the actuator 19 (arrow A), with the end of its piston rod 26 being attached to the actuator by a pivotable connection. The damping device 25 imparts a damped resistive force to the actuator 19 in a direction opposite to arrow A.

The mechanism 13 is seen in its pre-loaded condition in FIG. 2a, in which the spring 24 and the damping device 25 are both fully extended. The mechanism 13 is held in this condition by the actuator 19, which is latched by means of its first pin 20 being retained by one of the angled sections 22a of its guide track 22.

As the oven door 12 closes, the trigger 17 will move in the direction of arrow A and come into contact with the actuator 19. The initial effect of this will be to cause the actuator 19 to pivot as its first pin 20 rides up the angled section 22a of its guide track 22. This unlatches the actuator 19 and frees it for sliding movement in the direction of arrow A under the influence of the spring 24. As the actuator 19 pivots, a hook 28 on it engages with a hook 27 on the trigger 17, so that the trigger, and hence also the oven door 12, will be carried along with the actuator as it is drawn by the force of the spring 24.

FIG. 2b shows the condition of the mechanism 13 part-way through the sliding travel of the actuator 19 with the trigger 17 connected to it.

The actuator 19 continues in its sliding movement in the direction of arrow A until its second pin 21 reaches the end of its guide track 23. This is the position seen in FIG. 2c and is the locked condition of the mechanism 13. This corresponds to the closed position of the oven door 12.

It will be seen that the mechanism 13 incorporates a second tension spring 29. This spring 29 is selectively engagable with the actuator 19 via a tumbler 30. The tumbler 30 is designed to act as a camming device and toggles between two positions: one in which it is operatively engaged with the actuator 19 and the other in which it is disconnected from it.

The tumbler 30 is rotatably mounted on an axle 31 fitted to the housing 14. The spring 29 is connected at one end to the tumbler 30 via a pin 32. At its other end, the spring 29 is attached to the housing 14. The housing 14 incorporates a stop 33 for the tumbler 30 to abut against. The arrangement is such that the spring 29 will exert a torque on the tumbler 30 in a sense to hold it against the stop 33 (clockwise as viewed in FIG. 2a) in its toggling position where it is disconnected from the actuator 19. This corresponds with the pre-loaded condition of the mechanism 13 seen in FIG. 2a.

On one side of its pivot point, the tumbler 30 has a finger 34 which extends into the path of movement of the actuator 19. The actuator 19 is designed to make contact with the finger 34 in the course of its sliding movement in the direction of arrow A and cause the tumbler 30 to rotate (anti-clockwise as viewed in FIG. 2b). This rotation of the tumbler 30 will cause it to go “over centre”, with the effect that the force of the spring 29 will instantly switch to exerting a torque on it in the opposite sense (anti-clockwise as viewed in FIG. 2b). This forces the tumbler 30 into contact with the actuator 19 via a tongue 35 on the other side of its pivot point. The tongue 35 is profiled to act as a camming surface and is designed to enter into operative engagement with a groove 36 on the actuator 19.

When the spring 29 is exerting a torque on the tumbler 30 in an anti-clockwise sense (as viewed in FIG. 2c), the camming action of its tongue 35 engaging with the groove 36 will cause a force to be transmitted to the actuator 19 in the direction of arrow A. This in turn will transmit a force via the trigger 17 to the oven door 12. Thus, the two springs 24 and 29 act in parallel in exerting force on the door 12 in a sense to close it and hold it shut. In practice, the spring 29 will usually be stiffer than the spring 24.

The mechanism 13 is intended to return automatically to its pre-loaded condition upon opening of the oven door 12. As the door 12 is opened, the trigger 17 will move in a direction opposite to arrow A, pulling the actuator 19 along with it. This sliding movement of the actuator 19 takes place initially against the biassing action of both the return spring 24 and the door spring 29, although the damping device 25 offers little or no damping resistance. Movement of the actuator 19 in a direction opposite to arrow A will cause the tumbler 30 to rotate (clockwise as viewed in FIG. 2c), by the camming action of its tongue 35 engaging with the groove 36. This rotation of the tumbler 30 will continue until its tongue 35 disengages from the groove 36 and the pin 32 goes “over centre”, causing the spring 29 to snap the tumbler back into its at rest position against the stop 33.

The sliding movement of the actuator 19 will continue in a direction opposite to arrow A until its first pin 20 enters into the angled section 22a of its guide track 22. This causes the actuator 19 to pivot (anti-clockwise as viewed in FIG. 2a) and it will then be latched in this position by the pin 20 in the angled section 22a. At this point, the hooks 27, 28 disengage, releasing the connection between the actuator 19 and the trigger 17 and thus freeing the door 12 to continue its opening movement unhindered, leaving the mechanism 13 in its pre-loaded condition.

It can sometimes happen with mechanisms of this nature that they get out of sequence and need re-setting. The mechanism 13 here is designed to be capable of being re-set automatically. The re-setting procedure involves simply closing the oven door 12.

FIG. 3a shows the situation where for some reason the trigger 17 has failed to return the actuator 19 to its latched position, so that the mechanism 13 is not in its proper pre-loaded condition. When the oven door 12 is closed, the trigger 17 will be moved into engagement with the actuator 19. In this instance, the actuator 19 will be contacted by a ramped surface 37 on the trigger 17. The ramped surface 37 is designed to act like a cam and force the actuator 19 to pivot (anti-clockwise as viewed in FIG. 3a) about its second pin 21. This pivotal movement is enabled by a second angled section 22b of the first guide track 22, which allows clearance for receipt the first pin 20, as will be seen in FIG. 3b. Continued movement of the trigger 17 in the direction of arrow A will now enable re-engagement of the hooks 27, 28, so that the proper connection between the trigger and the actuator 19 is restored.

1. A damped closure mechanism for controlling movement of a first member relative to a second member, the mechanism comprising:
a housing having first spring biassing means engagable with the first member in use for urging it in a first direction,
damping means for providing damped resistance to said movement of the first member in the first direction, and
second spring biassing means engagable with the first member for urging it in the first direction, the second spring biassing means being arranged to act on the first member in parallel with the first spring biassing means.

2. A mechanism as claimed in claim 1 wherein the housing has an actuator movably mounted thereon for activating the first and second spring biassing means and the damping means.

3. A mechanism as claimed in claim 2 wherein the housing is mounted in use on the second member, and the actuator is arranged to impart forces from the first and second spring biassing means and the damping means to the first member via a trigger mounted in use on the first member.

4. A mechanism as claimed in claim 2 wherein the first spring biassing means is arranged to act constantly on the actuator.

5. A mechanism as claimed in claim 2 wherein the second spring biassing means is arranged to act selectively on the actuator.

6. A mechanism as claimed in claim 5 wherein the second spring biassing means is arranged to act on the actuator via a camming device.

7. A mechanism as claimed in claim 6 wherein the camming device is rotatably mounted on the housing.

8. A mechanism as claimed in claim 6 wherein the camming device toggles between two positions, with one being when it is operatively engaged with the actuator and the other being when it is disconnected from it.

9. A mechanism as claimed in claim 8 wherein the second spring biassing means is arranged to go over centre when the camming device toggles between its two positions.

10. A mechanism as claimed in claim 1 wherein the second spring biassing means is arranged to act later than the first spring biassing means during said movement of the first member in the first direction.

11. A mechanism as claimed in claim 1 wherein the second spring biassing means is designed to impart a stronger force than the first spring biassing means.

12. A mechanism as claimed in claim 1 wherein said first and second spring biassing means comprise linearly acting tension springs.

13. A mechanism as claimed in claim 1 wherein the first and second members are mounted for pivotal movement relative to each other about a vertical axis and the housing is arranged in use spaced remotely therefrom.

14. A mechanism as claimed in claim 3 wherein the first spring biassing means is arranged to act constantly on the actuator.

15. A mechanism as claimed in claim 3 wherein the second spring biassing means is arranged to act selectively on the actuator.

16. A mechanism as claimed in claim 4 wherein the second spring biassing means is arranged to act selectively on the actuator.

17. A mechanism as claimed in claim 7 wherein the camming device toggles between two positions, with one being when it is operatively engaged with the actuator and the other being when it is disconnected from it.
